(19) United States
(12) Patent Application Publication
(10) Pub. No.: US 2026/0338825 A1
(43) Pub. Date: Oct. 29, 2026

(54) ACTIVE VIBRATION CANCELLATION AND CONTROL FOR SCANNING PROBE MICROSCOPY

(71) Applicant: Rutgers, The State University of New Jersey, New Brunswick, NJ (US)

(72) Inventors: Qingze ZOU, New Brunswick, NJ (US); Jiarong CHEN, New Brunswick, NJ (US)

(73) Assignee: Rutgers, The State University of New Jersey, New Brunswick, NJ (US)

(21) Appl. No.: 19/102,592

(22) PCT Filed: Aug. 10, 2023
(86) PCT No.: PCT/US2023/030004

§ 371 Date: Feb. 10, 2025

Related U.S. Application Data
(60) Provisional application No. 63/396,754, filed on Aug. 10, 2022.
(60) Provisional application No. 63/448,132, filed on Feb. 24, 2023.

(51) Int. Cl. G01Q 30/06; G01Q 60/24; G06T 5/20; G06T 5/70

(52) U.S. Cl. CPC G01Q 30/06; G01Q 60/24; G06T 5/20; G06T 5/70; G06T 2207/10056; G06T 2207/20004

(57) ABSTRACT

Various embodiments comprise systems, methods, architectures, mechanisms and apparatus for processing an image including distortion induced by the presence of acoustic noise and/or ground vibration during the generation of the image by a sensitive imaging device such as an Atomic Force Microscopy (AFM) device. The initial filtered image may be obtained using a finite impulse response (FIR) filter g_{N}[k] configured to process an image noise signal \hat{z}ₙ[k] contemporaneously captured with the image.

### CROSS-REFERENCE TO RELATED APPLICATION

This application claims priority to U.S. Provisional Patent Application No. 63/396,754, filed on Aug. 10, 2022, entitled ACTIVE NOISE CANCELLATION FOR SCANNING PROBE MICROSCOPE IMAGERY (Attorney Docket No. RU-2022-144), and to U.S. Provisional Patent Application No. 63/448,132, filed on Feb. 24, 2023, entitled ACTIVE VIBRATION CANCELLATION AND CONTROL FOR SCANNING PROBE MICROSCOPY (Attorney Docket No. RU-2023-072), which applications are is incorporated herein by reference in their entireties.

### GOVERNMENT INTEREST

This invention was made with government support under grant numbers CMMI-1663055, CMMI-1851907 and IIBR-1952823 awarded by the NSF. The government has certain rights in the invention.

### FIELD OF THE DISCLOSURE

The present disclosure generally relates to image processing and, in particular, to minimizing scanning probe microscope (SPM) imaging distortion associated with acoustic sources and ground vibrations.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Atomic Force Microscopy (AFM) is sensitive to disturbances such as acoustic noise that causes distortions in AFM images. Some effects due to external disturbance can be reduced by conventional passive methods, however residual noise distortion remains, and such distortion results in image quality loss.

Challenges exist in filtering the acoustic-noise-caused distortions in AFM images. Conventional frequency-domain filtering approach (e.g., low-pass, band-pass filtering) is ineffective as the acoustic-noise effect is largely random, broadband, and does not decay with frequency increase. As a result, sample topography can be significantly distorted or removed along with the noise when using these filters.

Conventionally the state-of-the-art acoustic noise reduction in AFM industry is to use an acoustic noise enclosure (acoustic hood) to isolate and absorb environment acoustic noise from entering the local measurement surrounding of the AFM scanner. However, the acoustic hood is not only bulky and costly, but cannot reduce the acoustic noise to the level needed in applications such as the cleanroom nanometrology in semi-conductor industry. Also, the hood cannot be installed when AFM is integrated with other instruments such as optical microscope and environment control chamber for live biological sample measurements in biomedical and biological research and development.

### SUMMARY

Various deficiencies in the prior art are addressed by systems, methods, architectures, mechanisms and apparatus of processing an image including distortion induced by the presence of acoustic noise and/or ground vibration during the generation of the image by a sensitive imaging device such as an Atomic Force Microscopy (AFM) device. The initial filtered image may be obtained using a finite impulse response (FIR) filter g_{N}[k] configured to process an image noise signal \hat{z}ₙ[k] contemporaneously captured with the image.

A method of processing an image including distortion induced by the presence of acoustic noise during the generation of the image according to an embodiment comprises: receiving acoustic noise data from each of a plurality of microphones proximate an imaging device during operation of the imaging device to generate the image; using the acoustic noise data to determine an acoustic noise source location; using a dictionary-based method to estimate a primary acoustic dynamic (PAD) of the acoustic noise based on the determined location of the acoustic noise source; using a dictionary-based method to estimate the acoustic noise signal; using the estimated PAD and the estimated noise signal to obtain an initial filtered image; and optimizing a filter using adaptive coherence minimization to obtain thereby a filtered image. The initial filtered image may be obtained using a finite impulse response (FIR) filter g_{N}[k] configured to process an image noise signal \hat{z}ₙ[k].

The plurality of microphones proximate the imaging device may comprise three microphones M_{A}, M_{B}, and M_{C} placed at respective known locations a, b, and c, and the acoustic noise source location is estimated with respect to sensor-source distances calculated using the acoustic noise data and known locations of the three microphones.

The method may further comprise constructing, for use in the dictionary-based method to estimate the PAD of the acoustic noise, a dictionary of frequency responses of the PAD measured at selected locations, [symbol] _{G}_{ₙ}, in accordance with the following equation:

[symbol]

_{G}_{ₙ}=Gₙ(\vec{l}_{p,q},jωₖ)|\vec{l}_{p,q}∈ [symbol] ², ωₖ∈ [symbol] _{ω}, p=1, . . . ,Nᵣ, and q=1, . . . N_{θ}.

The method may further comprise constructing, for use in the dictionary-based method to estimate the acoustic noise signal, a dictionary of noise propagation dynamics (NPD) measured at selected locations, [symbol] _{G}_{ₙₚ}, in accordance with the following equation:

[symbol]

_{G}_{ₙₚ}=Gₙₚ(\vec{l}_{p,q},jωₖ)|\vec{l}_{p,q}∈ [symbol] ², ωₖ∈ [symbol] _{ω}, i=1,2, . . . Nᵣ, j=1,2, . . . N_{θ}.

A method of processing an image including distortion induced by the presence of vibration during the generation of the image according to an embodiment comprises: receiving vibration data from each of at least one vibration sensors proximate an imaging device during operation of the imaging device to generate the image; using the vibration data to determine an estimated noise signal n\hat{ }[k]; iteratively minimizing coherence between the vibration noise and residual vibration-caused image distortion to obtain updated noise signal n\hat{ }[k] and coherence Ĉ_{nz}(jωₖ, α_{i,t}); and generating filtered image data using the updated noise signal n\hat{ }[k] and coherence Ĉ_{nz}(jωₖ, α_{i,t}).

Additional objects, advantages, and novel features of the invention will be set forth in part in the description which follows and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts an AFM system benefiting from the various embodiments;

FIGS. 2A and 2B depict AFM images of a silicon waver obtained with and without, respectively, induced environmental acoustic noise;

FIG. 3 is a spectral diagram of illustrating an exemplary frequency response (magnitude part) of primary acoustic dynamics (PAD) such as for a noise source such as described above with respect to the AFM system of FIG. 1;

FIG. 4 is a schematic representation of the acoustic source localization using time delay measurements;

FIG. 5 is a schematic representation of the construction of a Dictionary of primary acoustic dynamics (PAD);

FIG. 6 depicts a pseudocode representation of a method for offline acoustic noise filtering according to an embodiment;

FIG. 7 depicts a flow diagram of a method according to an embodiment; and

FIG. 8 depicts a high-level block diagram of a noise rejection mode (NRM) process according to an embodiment;

FIG. 9 depicts an AFM system benefiting from the various embodiments;

FIG. 10 depicts a pseudocode representation of a method for vibration filtering according to an embodiment; and

FIG. 11 depicts a flow diagram of a method according to an embodiment.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art and are to be construed as being without limitation to such specifically recited examples and conditions. Additionally, the term “or” as used herein refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various embodiments provide systems, methods, architectures, mechanisms and apparatus for mitigating image distortions related to acoustic noise such as associated with Atomic Force Microscopy (AFM) and other processes sensitive to acoustic noise and similar disturbances.

Various embodiments contemplate a data-driven dictionary-based filtering approach to remove AFM image distortion caused by acoustic noise from an unknown location(s). Specifically, a filter is designed directly as the finite-impulse-response (FIR) representation of the underline primary acoustic dynamics (PAD) response. To account for the unknown noise location effect on the PAD, the unknown noise source is localized based on the time-delay measurement method. A dictionary-based approach is proposed to estimate the corresponding PAD based on the estimated noise location. An acoustic-dynamics modulator is introduced to the estimated PAD to minimize the acoustic-caused image distortion via coherence minimization. Particularly, the modulator is sought via a gradient-based iterative method to minimize the coherence between the acoustic noise and the residual acoustic-caused image distortion iteratively. The approach to minimize the coherence between the acoustic noise and the noise-distorted AFM image signal is newly applied herein, and a gradient-based algorithm is created to minimize the coherence and optimize the filter (i.e., the acoustic dynamics model). The proposed filtering scheme is implemented on AFM image examples, and experimental results have shown that image distortion is significantly reduced.

For example, various embodiments estimate a location of a noise source using a time-delay measurement method and to provide thereby an estimated the noise signal. An acoustic-dynamics modulator then minimizes the corresponding image distortion by minimizing the coherence between the acoustic noise and the filtered acoustic-noise-effected image through a gradient-based optimization.

Various embodiments contemplate online active noise-rejection-mode (NRM) imaging to handle acoustic-noise-caused cantilever probe vibration during AFM imaging. A pre-filter to online adjust the set point of the feedback loop for topography tracking to make the AFM system robust to the environment acoustic noise. A feedforward controller based on the PAD model of the acoustic noise effect on the AFM system is augmented to counter act noise-caused vibration.

Various embodiments provide active noise control/cancellation suitable for use in AFM imaging applications and the like so as to reduce or eliminate image distortion caused by acoustic noise. Some embodiments provide active noise control/cancellation during an SPM imaging or image acquisition process, while others provide active noise cancellation afterwards through a post-imaging process.

Various embodiments provide a dictionary-based approach integrated with time-delay measurement to localize acoustics noise source(s) and estimate corresponding acoustic dynamics in AFM imaging.

A noise-to-image coherence minimization approach is provided to minimize acoustic-caused image distortion via a gradient-based optimization.

A noise rejection mode (NRM) is provided to reduce/eliminate the acoustic noise caused disturbances to the AFM cantilever probe during the imaging process, wherein the set point of the feedback loop for tracking the sample topography is adjusted online to make the AFM system robust to the environmental noise, and a feedforward controller is augmented to counteract acoustic noise caused vibration in the feedback loop.

The various embodiments advantageously provide a data-driven approach to capture and use the acoustic noise dynamics. The acoustic noise dynamics tend to be complicated and vary with time. By using the data-driven approach, the acoustic noise dynamics can be captured by the finite impulse response (FIR) sequence directly without loss of robustness through a dictionary-based finite-impulse-response-based approach. Further, in various embodiments a modulator is introduced to further enhance the acoustic noise dynamics captured, and a coherence-minimization approach is used to optimize the modulator. Illustratively, a gradient-based coherence-minimization algorithm may be used to eliminate acoustic-noise-caused distortions in AFM images. Further, a noise-rejection-mode adapted for AFM imaging is also provided, which consists of both adaptive adjustment of a feedback loop (via a pre-filter) and feedforward noise cancellation. The noise reduction performance of the noise-rejection-mode is further enhanced using a Wiener filter.

The modulator-enhanced FIR filter can be used independently without using the acoustic dynamics dictionary, to compensate for the effect of unknown noise source location on the acoustic noise dynamics measurement, and thereby, directly cancel the acoustic-caused AFM image distortions. Thus, various embodiments provide modulation of one or more filters, such as modulation of an acoustic noise filter to optimize thereby a filter configured to minimize acoustic-noise-caused distortions in AFM images.

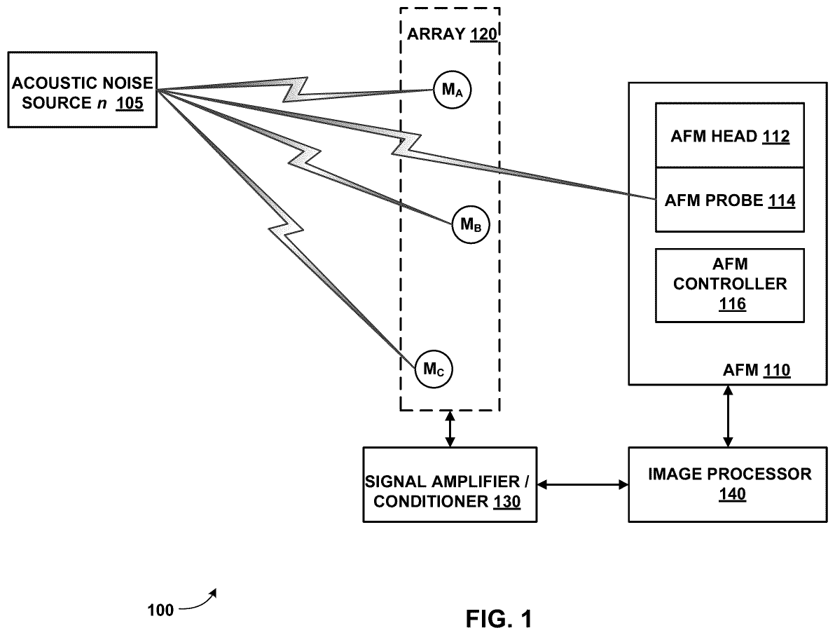

FIG. 1 depicts an AFM system benefiting from the various embodiments. Specifically, FIG. 1 depicts an AFM 110 comprising an AFM head 112 configured to cause scanning of a sample surface (not shown) by an AFM probe 112. An AFM controller 116 is configured to manage the various control and input/output functions of the AFM 110, such as providing AFM image data to an image processor 140. The image processor 140 is configured to process the AFM image data in accordance with the various embodiments, as will be discussed below.

FIG. 1 also depicts a microphone array 120 comprising, illustratively, three microphones denoted as microphones M_{A}, M_{B}, and M_{C} (collectively microphones M of the array 120). Acoustic information such as sounds/vibrations proximate the AFM 110 such as from an acoustic noise source 105 are received by the microphones M, which provide corresponding acoustic information signals that are provided to the image processor 140, optionally via signal amplification/conditioning circuitry 130. It is noted that the sounds/vibrations proximate the AFM 110 such as from the acoustic noise source 105 are also “received” by the AFM probe 114, either directly from the noise source 105 (or acoustic transmissive media therebetween), or indirectly via other portions of the AFM 110 that are also impacted or perturbed by sounds/vibrations proximate the AFM 110 and mechanically cooperating with the AFM probe so as to transmit sounds/vibrations thereto.

The effect of acoustic noise is to reduce AFM imaging quality. For example, in tapping mode (TM) imaging, a cantilever tip is excited (usually using a small piezo stack actuator, called a dither piezo) and taps on the sample surface, and the tapping amplitude is maintained around a pre-chosen constant level under feedback control, when the tip is scanning across the surface. Then, a sample topography image is obtained from the (vertical) displacement of the cantilever. In the presence of environmental acoustic noise, however, the mechanical structure of the AFM (on which the cantilever is mounted) can be excited and vibrate, resulting in unwanted cantilever vibration with respect to the sample and thereby, image distortion.

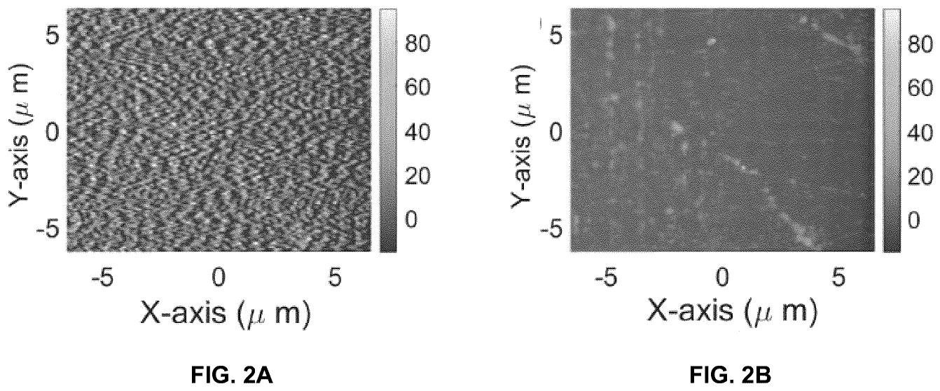

FIGS. 2A and 2B depict AFM images of a silicon wafer obtained with and without, respectively, induced environmental acoustic noise. Specifically, FIGS. 2A and 2B depict images of a silicon wafer obtained under environmental acoustic noise (e.g., such as discussed herein with respect to FIG. 1), wherein it can be seen that there is pronounced image distortion (FIG. 2A) in the presence of induced noise in comparison to the lower image distortion (FIG. 2B) in the image obtained without the induced noise.

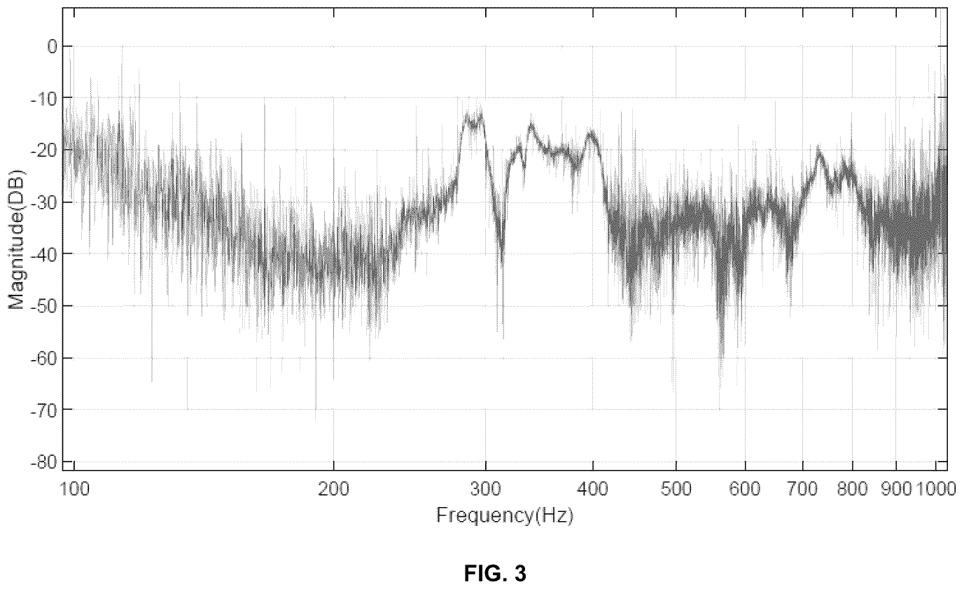

It is challenging to eliminate such acoustic-noise-caused distortions in an AFM image. Conventional filtering techniques based on frequency-domain separation (e.g., low-pass, band-pass, or notch filter) are ineffective as the noise-caused distortion is largely coupled with the sample topography in the image obtained. These techniques will filter out and smear the sample topography features. Further challenges arise as the acoustic-noise dynamics is largely random, broadband, and do not decay with the frequency increases, such as depicted in the spectral diagram of FIG. 3 which illustrates an exemplary frequency response (magnitude part) of a primary acoustic dynamics (PAD) such as from the noise source 105 of the AFM system of FIG. 1 to the piezoelectric actuator for tracking the sample topography (e.g., the AFM head 115 of FIG. 1).

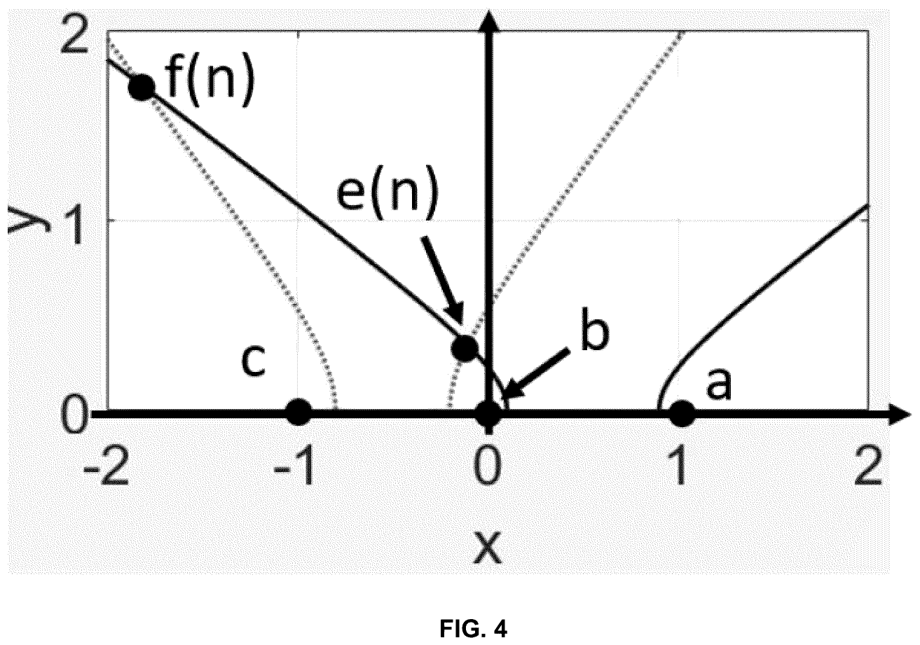

Of particular interest is the scenario where the acoustic noise comes from an arbitrary and unknown but fixed location behind the sensors (whose locations are fixed and known), as illustrated in FIG. 4, for example.

FIG. 4 is a schematic representation of the acoustic source localization using time delay measurement, where a, b, and c, denote the locations of three microphones, the solid-line and dashed-line are the hyperbola curves on which the possible noise source locations are located, while e(n) and f(n) denote the location of the noise source n, respectively.

Referring to FIG. 4, the location of the noise source n (105) with respect to three microphones M_{A}, M_{B}, and M_{C} placed at respective known locations a, b, and c, can be determined to be at one of the two intersections of two hyperbola, one with its foci at a and b, and the other with its foci at b and c.

The hyperbola with the foci at a and b (the solid lines in FIG. 4) is given by the following equation:

$$\frac{{( x - 0.5 )}^{2}}{{( Δ {d}_{a - b , n} / 2 )}^{2}} - \frac{{y}^{2}}{{0.5}^{2} - {( Δ {d}_{a - b , n} / 2 )}^{2}} = 1 \qquad ( 1 )$$

where to simplify the expression, the coordinate has been chosen with b at the origin and a at coordinate (1,0).

Similarly, the hyperbola with foci at locations b and c (the dashed line in FIG. 4) is given by the following equation:

$$\frac{{( x + 0.5 )}^{2}}{{( Δ {d}_{b - c , n} / 2 )}^{2}} - \frac{{y}^{2}}{{0.5}^{2} - {( Δ {d}_{b - c , n} / 2 )}^{2}} = 1 , \qquad ( 2 )$$

where to simplify the expression, the third microphone location is at c(−1, 0), and where Δd_{b-c,n}=|d_{b,n}−d_{c,n}|, and where the constant of 0.5 in the above Eqs. (1) and (2) is adjusted if the two microphones at b and c are not at coordinate (1, 0) and (−1, 0) respectively, and can be determined based on their locations accordingly.

The noise source location n can be determined once the sensor-source distance differences Δd_{a-b,n} and Δd_{b-c,n} in Eqs. (1), (2), respectively, are quantified, or equivalently, the time difference between the noise signals captured by the three microphones at a, b, and c, τ_{ab}, and τ_{bc}, respectively, are quantified. This time difference is measured/quantified through the following cross-correlation between these three acoustic signals, e.g., the time difference τ_{ab} is quantified through cross-correlation R_{ab}[j], as given by the following equation:

$${R}_{ab} [ j ] = {\sum }_{k = 0}^{{N}_{I} - 1} {n}_{a} [ k ] {n}_{b} [ ( k + j ) mod {N}_{I} ] j = 0 , 1 , 2 , … , {N}_{I} - 1 \qquad ( 3 )$$

where mod denotes the modulo operation.

The time delay τ_{ab} (for quantifying the distance difference), Δd_{a-b,n}) is obtained as the maximum value of the cross-correlation, as given by:

$${τ}_{ab} = \frac{1}{{f}_{s}} arg {max}_{j} ( {R}_{ab} [ j ] ) . \qquad ( 4 )$$

where fₛ is the sampling frequency.

The distance difference Δd_{b-c,n} is quantified in the same manner. Finally, the coordinates of the noise location, [symbol] =(xₙ, yₙ), is obtained by solving the 2^{nd}-order algebraic equations Eqs. (1) and (2).

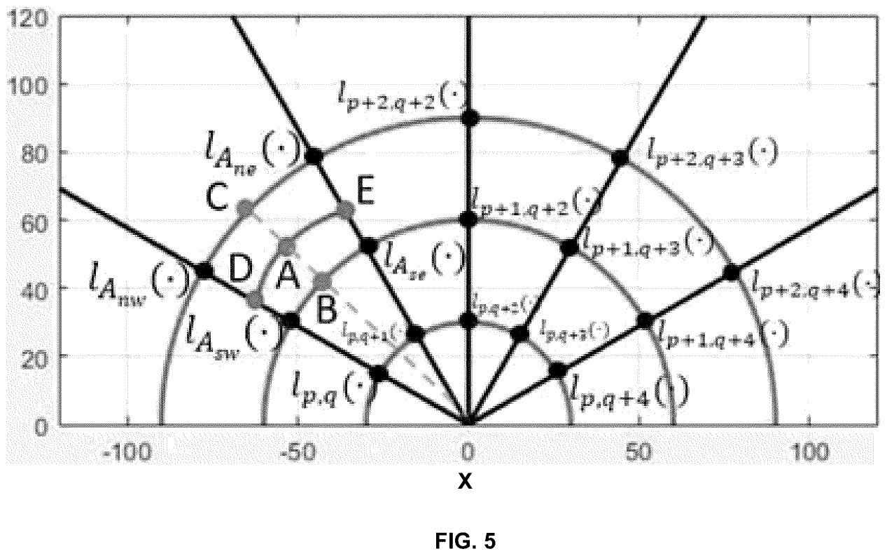

FIG. 5 is a schematic representation of the construction of a Dictionary of primary acoustic dynamics (PADs), where the receiver (e.g., the AFM scanner in this work) is located at the origin, the dots on the half-circle grids are the locations at which the PADs in the dictionary have been measured, and the dots at B, C, D and E denote the locations of the PADs that are estimated by using the dictionary and then used to estimate the PAD at location “A” (dot A is between dots B and C) at which the unknown noise source is, respectively.

A dictionary of the frequency responses of the primary acoustic dynamics (PAD) measured at selected locations, [symbol] , is constructed as per the following:

[symbol]

=Gₙ( [symbol] ,jωₖ)| [symbol] ∈ [symbol] ,ωₖ∈ [symbol] , p=1, . . . Nᵣ, and q=1, . . . ,N_{θ} (5)
and where

$${𝕊}_{ω} = \{ \frac{k {ω}_{s}}{{N}_{I}} \vert k = 0 , 1 , , {N}_{I} - 1 , and {ω}_{s} = 2 π {f}_{s} \} \qquad ( 6 )$$

is the set of the sampled discretized frequencies, Gₙ( [symbol] ,jωₖ) is the PAD from location [symbol] ( [symbol] =(rₚ, θ_{q}): the polar coordinate of position) to the AFM image signal measured under the noise-sensor collocated condition, and N_{θ} and Nᵣ are the total number of PADs measured in the polar direction and radical direction, respectively (e.g., as per FIG. 5).

That is, for [symbol] =(rₚ, θ_{q}):

$${r}_{p} = \frac{{r}_{max}}{{N}_{r} - i} , {θ}_{q} = \frac{{θ}_{max}}{q} \qquad ( 7 )$$

for 1≤p≤Nᵣ and 1≤q≤N_{θ} (8)
where rₘₐₓ and θₘₐₓ are the radius and angle (with respect to the AFM cantilever) corresponding to the maximum area of the noise effect considered, respectively.

The PAD at an unknown location can be estimated by using the dictionary [symbol] via, e.g., linear interpolation. Specifically, two constants, μᵣ and μ_{θ}∈(0,1), are introduced to account for the dependence of the PADs on the distance (μᵣ) and the direction (i.e., angle, μ_{θ}) with respect to the AFM cantilever, respectively. For example to estimate the PAD at location A in FIG. 2, first the smallest grid of the dictionary [symbol] within which location A resides can be determined by using the estimated location of A (as discussed above), i.e., Aₙₑ, A_{nw}, Aₛₑ, and A_{sw} in FIG. 2 can be determined. Then the distance effect can be accounted for by using the Dictionary [symbol] _{G}_{ₙ} to estimate the PAD at locations B and C (such as depicted in FIG. 5), Ĝ_{N,B}(jωₖ) and Ĝ_{N,C}(jωₖ) as follows:

Ĝ_{N,B}(jωₖ)=(1−μ_{θ})Gₙ(\vec{l}_{A}_{_{sw}},jωₖ)+μ_{θ}Gₙ(\vec{l}_{A}_{ₛₑ},jωₖ) (9)

Ĝ_{N,C}(jωₖ)=(1−μ_{θ})Gₙ(\vec{l}_{A}_{_{nw}},jωₖ)+μ_{θ}Gₙ(\vec{l}_{A}_{ₙₑ},jωₖ) (10)
for ∀ωₖ∈ [symbol] _{ω} where Gₙ(\vec{l}_{A}_{_{sw}},jωₖ), Gₙ(\vec{l}_{A}_{ₛₑ},jωₖ), Gₙ(\vec{l}_{A}_{_{nw}},jωₖ) and
Gₙ(\vec{l}_{A}_{ₙₑ},jωₖ)∈ [symbol] _{G}_{ₙ} are the corresponding PADs at locations Aₙₑ, A_{nw}, Aₛₑ, and A_{sw}, respectively (such as depicted in FIG. 5).

Then the dynamic at location A can be estimated via linear interpolation in the radical direction, as follows:

Ĝ_{N,A}(ωₖ)=(1−μᵣ)Ĝ_{N,B}(jωₖ)+μᵣĜ_{N,C}(jωₖ) (11)

Alternatively, Ĝ_{N,A}(ωₖ) can also be estimated by accounting for the distance effect first—by estimating the PAD at location D and E (See FIG. 2), Ĝ_{N,D}(jωₖ) and Ĝ_{N,E}(jωₖ), respectively, then secondly, the direction effect by using the obtained Ĝ_{N,D}(jωₖ) and Ĝ_{N,E}(jωₖ) via linear interpolation in the polar direction. The accuracy of Ĝ_{N,A}(ωₖ) can be further improved via averaging.

The effect of unknown noise location on the noise measurement can also be accounted for via the data-driven, dictionary-based approach. A dictionary of the noise propagation dynamics (NPD) measured at selected locations, [symbol] _{G}_{ₙₚ}, is constructed a priori, as follows:

[symbol]

_{G}_{ₙₚ}=Gₙₚ(\vec{l}_{p,q},jωₖ)|\vec{l}_{p,q}∈ [symbol] ², ωₖ∈ [symbol] _{ω}, i=1,2, . . . Nᵣ, j=1,2, . . . N_{θ} (12)
where Gₙₚ(\vec{l}_{p,q},jωₖ) is the NPD measured with the noise source (speaker) at location l_{p,q}=(rᵢ,θⱼ) and the sensor (microphone) located at the given fixed location, e.g., with the noise at location e(n) and the sensor at the origin in FIG. 5. The location of the microphone is chosen the same as that during the targeted imaging process.

The NPD at any unknown location A, Ĝ_{A}(jωₖ), can be obtained as the average of the direction-first and the distance-first estimations, Ĝ_{A,ρ}(jωₖ), Ĝ_{A,d}(jωₖ), respectively, as follows:

$${\hat{G}}_{A} ( j {ω}_{k} ) = \frac{1}{2} {\hat{G}}_{A , ρ} ( j {ω}_{k} ) + \frac{1}{2} {\hat{G}}_{A , d} ( j {ω}_{k} ) \qquad ( 13 )$$

whereas in the PAD estimation above, the direction-first estimation Ĝ_{A,ρ}(jωₖ) is obtained via:

Ĝ_{A,ρ}(jωₖ)=(1−μᵣ)Ĝ_{B}( [symbol] ,jωₖ)+μᵣĜ_{C}( [symbol] ,jωₖ) (14)
with Ĝ_{B}(jωₖ), Ĝ_{C}(jωₖ) the NPDs estimated at location-B and location-C, respectively, by using the dictionary [symbol] —similar to Eqs. (9), (10), (11) and the distance-first estimation Ĝ_{A,d}(jωₖ) is obtained via the following:

Ĝ_{A,d}(jωₖ)=(1−μ_{ρ})Ĝ_{D}( [symbol] ,jωₖ)+μ_{ρ}Ĝ_{E}( [symbol] ,jωₖ) (15)
with Ĝ_{D}(jωₖ), Ĝ_{E}(jωₖ) the estimated NPDs at location-D and location-E, respectively, using the dictionary [symbol] , similar to Eqs. (9), (10), (11).

With the above estimated NPD, the noise at location A during the targeted imaging process can be estimated from the measured noise N_{A,m}(jωₖ) as:

$${\hat{N}}_{cl} ( j {ω}_{k} ) = \frac{{N}_{A , m} ( j {ω}_{k} )}{{G}_{A} ( j {ω}_{k} )} , for {ω}_{k} ∈ {𝕊}_{ω} \qquad ( 16 )$$

The above estimated PAD and NPD, in the non-parametric finite impulse response form, may be used directly to quantify the noise-caused image distortion (i.e., the image noise signal \hat{z}ₙ[k] as follows:

z_{F}[k]=z[k]−\hat{z}ₙ[k], for k=1, . . . ,N₁ (17)

wherein \hat{z}ₙ[k]=\hat{n}_{cl}[k]*ĝ_{N}[k] (18)
where the PAD Ĝ_{N}(z) and NPD Ĝ_{A}(z) are represented in finite-impulse-response (FIR) form g_{N}[k]:

$${\hat{G}}_{n} ( z ) \approx {\sum }_{k = 0}^{{K}_{n} - 1} {ω}_{k} {z}^{- k} = {\sum }_{k = 0}^{{K}_{n} - 1} {g}_{N} ( k ) {z}^{- k} \qquad ( 19 )$$

$${\hat{G}}_{A} ( z ) \approx {\sum }_{j = 0}^{{K}_{A} - 1} {ω}_{j} {z}^{- j} = {\sum }_{j = 0}^{{K}_{A} - 1} {g}_{A} ( k ) {z}^{- k} \qquad ( 20 )$$

and Kₙ and K_{A} are the chosen order of the FIR filter.

A dynamic modulator α*(jωₖ)∈ [symbol] is introduced to the PAD filter Ĝ_{N}(jωₖ),

Ĝ_{N}*(jωₖ,αᵢ)=α*(jωₖ)Ĝ_{N}ωₖ),ωₖ∈ [symbol] , (21)
is designed to account for the imaging-dependent effect on the filter Ĝ_{N}(jωₖ) and further improve the filtering quality, such that the following cost function is minimized:

$$min {J}_{r} = {\sum }_{k = 1}^{{N}_{I}} E {\{ {e}_{r} [ k ] \}}^{2} = {\sum }_{k = 1}^{{N}_{I}} E {\{ {z}_{F} [ k ] - {z}_{T} [ k ] \}}^{2} \qquad ( 22 )$$

A substantially optimal modulator α*(jωₖ) is obtained through the gradient descent search method, i.e., for any given ωₖ∈ [symbol] , as follows:

Ĝ_{N,i}(jωₖ,αᵢ)=αᵢ(ωₖ)Ĝ_{N}(jωₖ), (23)

$$with {α}_{i} ( j {ω}_{k} ) = {α}_{i - 1} ( j {ω}_{k} ) + λ \frac{\partial {𝒥}_{r}}{\partial {\hat{G}}_{N , i - 1} ( j {ω}_{k} )} = ( j {ω}_{k} ) + λ \frac{\partial {𝒥}_{r}}{\partial {α}_{i - 1} ( j {ω}_{k} )} \frac{1}{{\hat{G}}_{N} ( j {ω}_{k} )} \qquad ( 24 )$$

for i≥1, where initially α₀ is chosen as one, λ∈(0,1) is a pre-chosen constant, and [symbol] is the frequency-domain representation of the cost function Jᵣ,
respectively, as follows:

$${𝒥}_{r} = {\sum }_{{ω}_{k} = 0}^{{N}_{I}} {[ {Z}_{F} ( j {ω}_{k} ) - {Z}_{T} ( j {ω}_{k} ) ]}^{2} , \qquad ( 25 )$$

as by the Parseval's Theorem, [symbol] =Jᵣ.

The minimization of Eq. (22) is converted to minimizing the coherence between the measured noise and the filtered image signal Z_{F}[k], based on the fact that the correlation between the acoustic noise n[k] and the true sample topography z_{T}[k], Rₙₜ[j], is zero:

Rₙₜ[j]=En[k−j]z_{T}[j]=0, j=0,1,2, . . . ,N_{I}−1. (26)

When the noise is completely removed:

R_{nf}[j]=En[k−j]z_{F}[j]→0 j=0,1,2, . . . ,N_{I}−1. (27)

Minimizing Jᵣ is equivalent to minimizing the following cost function J_{c} of the correlation between z_{F}[k] and n[k]:

$${J}_{c} = {\sum }_{j = 1}^{{N}_{I}} {{R}_{nf} [ j ]}^{2} = {\sum }_{j = 1}^{{N}_{I}} E {\{ n [ k - j ] {z}_{F} [ j ] \}}^{2} \qquad ( 28 )$$

The above cost function in Eq. (28) can be represented in frequency domain as follows:

$$min {𝒥}_{c} = {\sum }_{k = 1}^{{N}_{F}} {E [ N * ( j {ω}_{k} ) {Z}_{F} ( j {ω}_{k} ) ]}^{2} \qquad ( 29 )$$

where N_{F} denotes the total number of effective frequency components in the noise source n[k] and the filtered image sequence z_{F}[k], i.e., ω_{N}_{_{F}} is the lowest frequency at which the magnitude of \hat{N}(jωₖ) becomes negligible, e.g., |N(jωₖ)|≤ϵₙ for all ωₖ≥N_{F} and ϵₙ is the chosen threshold value.

The above correlation minimization in Eq. (29) is converted to minimizing the corresponding coherence between these two signals, C_{nf}(jωₖ), by normalizing J_{c} with the (estimated) power spectral density of Z_{F}(jωₖ) and N(jωₖ), as follows:

$$min {𝒥}_{c} = {\sum }_{k = 1}^{{N}_{F}} \frac{{E [ N * ( j {ω}_{k} ) {Z}_{F} ( j {ω}_{k} ) ]}^{2}}{{P}_{N} ( j {ω}_{k} ) {P}_{{Z}_{F}} ( j {ω}_{k} )} \qquad ( 30 )$$

$${=}^{△} {\sum }_{k = 1}^{{N}_{F}} {C}_{nf} ( j {ω}_{k} ) \qquad ( 31 )$$

where the P_{N}(jωₖ) and P_{Z}_{_{F}}(jωₖ) are power spectral densities of N(jωₖ) and Z_{F}(jωₖ), respectively. When the coherence C_{nf}(jωₖ)∈(0,1) is minimized, so is [symbol] . Thus, the gradient-based iteration in Eq. (24) is converted to:

$${α}_{i} ( j {ω}_{k} ) = {α}_{i - 1} ( j {ω}_{k} ) + λ \frac{\partial {C}_{nf} ( j {ω}_{k} , {α}_{i - 1} )}{\partial {\hat{G}}_{N , i - 1} ( j {ω}_{k} )} \qquad ( 32 )$$

$$= {α}_{i - 1} ( j {ω}_{k} ) + λ \frac{\partial {C}_{nf} ( j {ω}_{k} , {α}_{i - 1} )}{\partial {α}_{i - 1} ( j {ω}_{k} )} \frac{1}{{G}_{N} ( j {ω}_{k} )} \qquad ( 33 )$$

where C_{nf}(jωₖ,αᵢ) is the coherence computed by modulator value obtained in the i^{th} iteration, αᵢ(jωₖ), i.e., in Eq. (30):

$${Z}_{F} ( j {ω}_{k} ) = {Z}_{F} ( j {ω}_{k} , {α}_{i} ) = Z ( j {ω}_{k} ) - \hat{N} ( j {ω}_{k} ) {\hat{G}}_{N , i} ( j {ω}_{k} ) = Z ( j {ω}_{k} ) - \hat{N} ( j {ω}_{k} ) {α}_{i} ( j {ω}_{k} ) {\hat{G}}_{N} ( j {ω}_{k} ) , \qquad ( 34 )$$

and the partial derivative ∂C_{nf}(jωₖ)/∂αᵢ(jωₖ) is computed numerically via the first-order Euler formula:

$$\frac{\partial {C}_{n f} ( j {ω}_{k} , {α}_{i} )}{\partial α ( j {ω}_{k} )} \approx \frac{{C}_{nf} ( j {ω}_{k} , {α}_{i} + δα ) - {c}_{nf} ( j {ω}_{k} , {α}_{i} )}{δα} \qquad ( 35 )$$

The coherence C_{nf}(jωₖ,αᵢ) is computed using the Welch's Method as the average of the short-segment coherence Ĉ_{nf,r}(jωₖ,αᵢ), i.e., for any given α:

$${C}_{nf} ( j {ω}_{k} , α ) \approx {\hat{C}}_{nf} ( j {ω}_{k} , α ) = \frac{{\sum }_{r = 1}^{{M}_{c}} {C}_{nf , r} ( j {ω}_{k} , α )}{{M}_{c}} \qquad ( 36 )$$

$$with$$

$${C}_{nf , r} ( j {ω}_{k} , α ) = \frac{{\vert {N}_{r}^{*} ( j {ω}_{k} ) {Z}_{F , r} ( j {ω}_{k} , α ) \vert}^{2}}{{P}_{N , r} ( j {ω}_{k} ) {P}_{F , r} ( j {ω}_{k} , α )} \qquad ( 37 )$$

for i≥1, where Nᵣ(jωₖ) and Z_{F,r}(jωₖ,α) are the Fourier transform of the r^{th} segment of the estimated noise signal \hat{n}[k] and the filtered image signal

$${z}_{F}^{α} [ k ] ,$$

respectively, obtained by partitioning the sequence of n[k] and

$${z}_{F}^{α} [ k ]$$

into M_{c} segments, respectively,

$$\hat{n} = [ {n}_{1} {n}_{2} ⋯ {n}_{r} ⋯ {n}_{{M}_{c}} ] \qquad ( 38 )$$

$$and$$

$${z}_{F}^{α} = [ {z}_{F , 1}^{α} {z}_{F , 2}^{α} ⋯ {z}_{F , r}^{α} ⋯ {z}_{F , {M}_{c}}^{α} ] , \qquad ( 39 )$$

$$where$$

$${n}_{r} = [ n ( ( r - 1 ) L + 1 ) , n ( ( r - 1 ) L + 2 , ⋯ , n ( rL ) ] \qquad ( 40 )$$

$${z}_{F , r}^{α} = [ {z}_{F , r}^{α} [ ( r - 1 ) L + 1 ] , {z}_{F , r}^{α} [ ( r - 1 ) L + 2 ] , ⋯ , {z}_{F , r}^{α} ( rL ) ] . \qquad ( 41 )$$

where the length of each segment L is chosen such that the sampled frequency resolution of each segment is high enough to capture the frequencies where the peak of coherence occurs, i.e., fₛ/L≤ϵ_{f} for ϵ_{f} is the chosen frequency resolution.

The minimization in Eq. (30) is further modified as:

$$min {𝒥}_{c} = {\sum }_{k = 1}^{{N}_{F}} {\hat{C}}_{nf} ( j {ω}_{k} ) - Var [ {\hat{C}}_{nf} ( j {ω}_{k} ) ] \qquad ( 42 )$$

where Var[Ĉ_{nf}(jωₖ)] is the variance of the estimated Ĉ_{nf}(jωₖ), and:

$${lim}_{{N}_{I} \to ∞} Var [ {\hat{C}}_{nf , i} ( j {ω}_{k} ) ] = E \{ {[ {\hat{C}}_{nf , i} ( j {ω}_{k} ) - {C}_{nf , i} ( j {ω}_{k} ) ]}^{2} \} \qquad ( 43 )$$

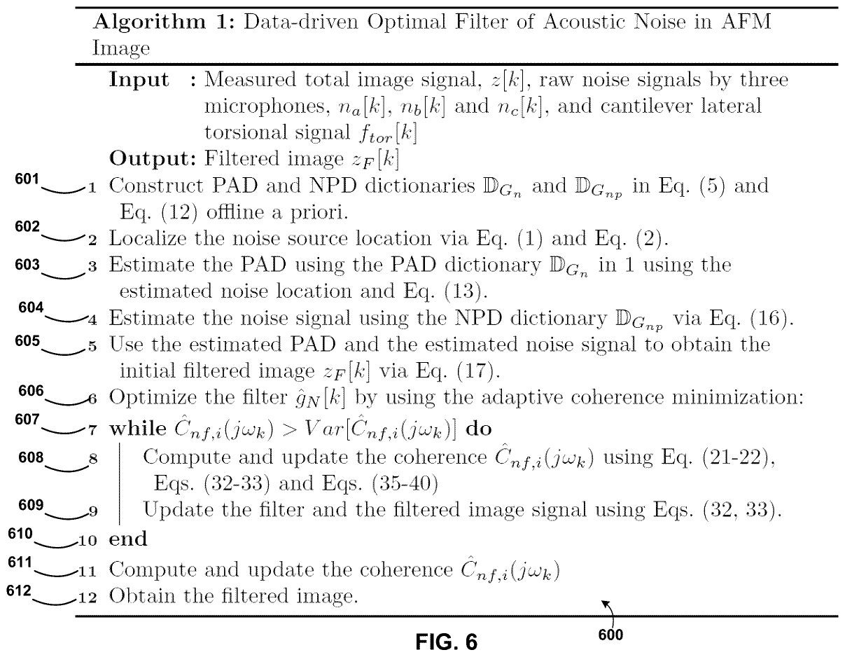

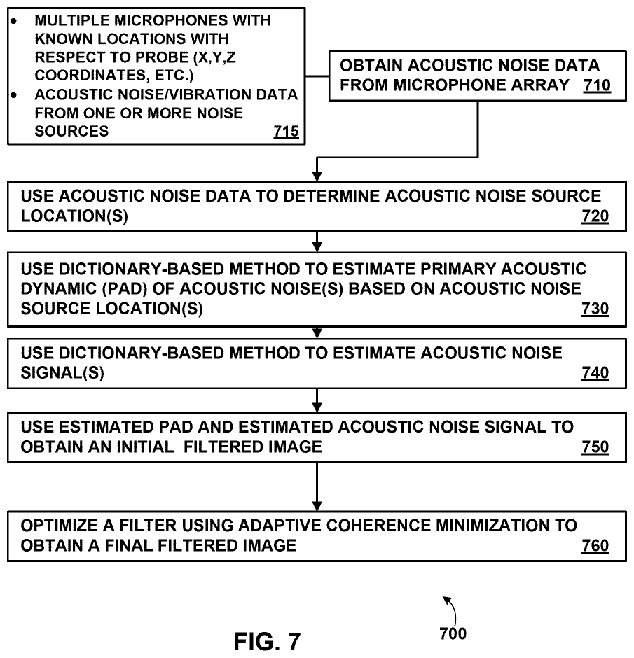

FIG. 6 depicts a pseudocode representation of a method for offline acoustic noise filtering according to an embodiment. Specifically, a methodology according to an embodiment for implementing an offline acoustic noise filtering is summarized in FIG. 6 and Algorithm 1 as presented below. FIG. 7 depicts a flow diagram of a method according to an embodiment and in accordance with the method of FIG. 6. It is noted that the description of FIGS. 6 and 7 are similar and, as such, will be presented together.

The embodiments of FIGS. 6 and 7 provide methods of processing an image including distortion induced by the presence of acoustic noise during the generation of the image by an imaging device sensitive to such acoustic noise, such as an Atomic Force Microscopy (AFM) device and the like as discussed above.

Referring to FIG. 7, at step 710 acoustic noise data from each of a plurality of microphones such as within a microphone array proximate an imaging device, and active during operation of the imaging device to generate the image, is received. Referring to box 715, and as depicted with respect to FIG. 1 and other examples above, the acoustic noise data may comprise data from three microphones having known locations with respect to and proximate an AFM device during the operation of the AFM device to provide thereby an image file or image data, wherein the image file or image data includes distortion induced by the presence of acoustic noise during the generation of the image file or image data by the AFM device.

At step 720 of the method 700 of FIG. 7 (step 602 of the method 600 of FIG. 6), the received acoustic noise data is used to determine an acoustic noise source location or locations.

At step 730 of the method 700 of FIG. 7 (step 603 of the method 600 of FIG. 6), a dictionary-based method to estimate a primary acoustic dynamic (PAD) of the acoustic noise based on the determined location of the acoustic noise source. Prior to the performance of step 730, a PAD dictionary is constructed such as in accordance with step 601 of the method 600 of FIG. 6.

At step 740 of the method 700 of FIG. 7 (step 604 of the method 600 of FIG. 6), a dictionary-based method is used to estimate the acoustic noise signal. Prior to the performance of step 740, a noise propagation dynamics (NPD) dictionary is constructed such as in accordance with step 601 of the method 600 of FIG. 6.

At optional step 750 of the method 700 of FIG. 7, the measured noise signal is subjected to a Wiener-filter-based optimizing filtering as described herein so as to improve the SNR of the measured noise signal.

At step 760 of the method 700 of FIG. 7 (step 605 of the method 600 of FIG. 6), the estimated PAD and the estimated noise signal are used to obtain an initial filtered image.

At step 770 of the method 700 of FIG. 7 (steps 606-612 of the method 600 of FIG. 6), the filter associated with the initial filtered image is optimized using adaptive coherence minimization to obtain thereby a final filtered image.

The above-described embodiments are primarily described within the context of post-processing of image data (i.e., after image capture) including distortion induced by the presence of acoustic noise during image data capture. That is, data related to acoustic noise is contemporaneously captured with the image data subject to being distorted or influenced thereby, and upon capturing the image data of substantially an entire image the various embodiments use the contemporaneously acoustic noise data to process the image so as to remove or at least reduce the distorting influence of the acoustic noise present at the time of the image data capture.

Various other embodiments are directed to online active noise control, wherein during the capture of image data susceptible to a distorting influence of acoustic noise. The online active noise control embodiments will now be described in more detail.

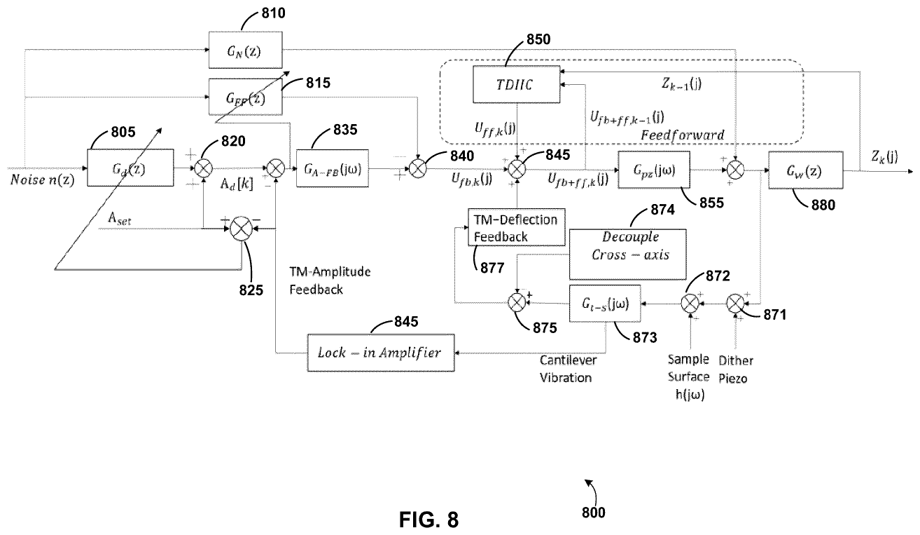

FIG. 8 depicts a high-level block diagram of a noise rejection mode (NRM) process/processor according to an embodiment. Specifically, the NRM processor 800 of FIG. 8 is configured to reduce the impact of acoustic noise n(z) within the context of AFM imaging.

Specifically, in the presence of the acoustic noise n(z), AFM cantilever deflection during the imaging process may be given as follows:

$$( 44 )$$

$$\begin{matrix}d ( z ) = S ( z ) [ ( - {G}_{FF} ( z ) {G}_{s} ( z ) + {G}_{N} ( z ) ) n ( z ) + {G}_{FB} ( z ) {G}_{s} ( z ) {A}_{d} ( z ) + {G}_{c} ( z ) h ( z ) ] \\ = S ( z ) [ {G}_{NC} ( z ) n ( z ) + {G}_{FB} ( z ) {G}_{s} ( z ) {A}_{set} + {G}_{c} ( z ) h ( z ) ]\end{matrix}$$

where S(z) is the sensitivity of the feedback closed loop,

$$S ( z ) = \frac{1}{1 + {G}_{FB} ( z ) {G}_{s} ( z )} \qquad ( 45 )$$

G_{NC}(z) is the dynamics from the noise to the cantilever deflection:

G_{NC}(z)=−G_{FF}(z)Gₛ(z)+G_{N}(z)+G_{FB}(z)Gₛ(z)G_{d}(z) (46)
and Gₛ(z)=G_{pz}(z)G_{c}(z) is the dynamics from the z-axis piezo actuator to the cantilever, respectively.

In Eq. (46), G_{N}(z) is the primary acoustic dynamics (PAD) from the acoustic noise to the z-axis piezo movement.

A feedforward controller G_{FF}(z) (815) configured to eliminate the acoustic noise effect on the cantilever deflection has a function given by:

G_{FF}(z)=Ĝ_{N}(z)Gₛ⁻¹(z) (47)
where Ĝ_{N}(z) is a model of the PAD G_{N}(z).

Under this feedforward controller 815, the cantilever deflection is given by:

d(z)=S(z)[(E(z)+G_{FB}(z)Gₛ(z)G_{d}(z))n(z)+G_{FB}(z)Gₛ(z)Aₛₑₜ+G_{c}(z)h(z)] (48)
where E(z) is the error dynamics between the true PAD G_{N}(z) and its model Ĝ_{N}(z):

E(z):=G_{N}(z)−Ĝ_{N}(z) (49)

A pre-filter of a set-point G_{d}(z) (850) imparted to an input noise signal n(z), is determined as follows:

$${G}_{d} ( z ) = - E ( z ) {G}_{FB}^{- 1} ( z ) {G}_{s}^{- 1} ( z ) \qquad ( 50 )$$

so as to eliminate the acoustic noise from the feedback loop and the feedback controller won't respond to the acoustic-noise-caused cantilever vibration, and the set-point of the cantilever deflection is online adjusted for noise rejection as

A_{d}(z)=Aₛₑₜ−G_{d}(z)n(z) (51)

As such, the acoustic-noise-caused cantilever deflection is removed from the feedback error signal e_{d}(k) is shown in FIG. 8, and the noise n(z) is substantially rejected out of the feedback loop.

The pre-filter G_{d}(z) in Eq. (50) is measured under the following conditions: (1) The acoustic noise exists in the spatial environment of the AFM system; (2) The AFM cantilever probe is engaged on a hard reference sample with the desired preload amplitude (force) for the chosen imaging mode (e.g., tapping mode, contact mode, or peak-force mode), without lateral displacement; (3) The feedforward controller G_{FF}(z) in Eq. (47) is applied along with the feedback controller G_{FB}(z); and (4) A measure of the acoustic noise n(z) and the deflection error e_{d}(z), and the G_{d}(z) is obtained as:

$${G}_{d} ( z ) = \frac{{\hat{e}}_{d} ( z )}{\hat{n} ( z )} \qquad ( 52 )$$

During the imaging process, the feedforward controller for acoustic noise cancellation G_{FF}(z) (815) and the pre-filter G_{d}(z) (805) are implemented in their finite-impulse-response (FIR) form as described above with respect to equations 17-20, and then updated online using a normalized least square mean algorithm. The FIR coefficients of the controller G_{FF}(z), h_{FF}[k], and those of the pre-filter G_{d}(z), h_{d}[k], are updated as:

$${h}_{FF} [ k + 1 ] = {h}_{FF} [ k ] + μ \frac{{e}_{FF} [ k ] * n [ k ]}{n [ k ] * n [ k ]} \qquad ( 53 )$$

$${h}_{d} [ k + 1 ] = {h}_{d} [ k ] + μ \frac{{e}_{d} [ k ] * n [ k ]}{n [ k ] * n [ k ]} \qquad ( 54 )$$

where

e_{FF}[k]=A_{d}[k]−A[k]−h_{FF}[k]*n[k] (55)

e_{d}[k]=Aₛₑₜ−A_{d}[k]−h_{d}[k]*n[k] (56)
and * denotes convolution operation, such as, for example:

$${e}_{FF} [ k ] * n [ k ] = {\sum }_{m = 0}^{M} {e}_{FF} [ m ] n [ k - m ] \qquad ( 57 )$$

where M is the length of the signals. The convolution of other signals above is given in the same matter.

A time-domain inversion-based iterative control (TDIIC) algorithm 850 is optionally applied to improve topography tracking performance, as follows:

u_{ff,0}(j)=0, (58)

u_{ff,k+1}(j)=kᵢₙᵥ(j)h_{k+1,d}(j) for j=0,1,2, . . . ,N−1 (59)
where kᵢₙᵥ(j) is the iterative gain updated point-by-point, and h_{k,d}(⋅) is the desired sample topography to track in the k^{th} iteration, respectively.

In the presence of acoustic noise, the sample topography on the k^{th} scan line, h_{k,d}(⋅), is estimated by using the k−1^{th} estimation h_{k-1,d}(⋅), the tapping amplitude error and the TM deflection as follows:

h_{k,d}(j)=hₖ₋₁(j)+k_{h,a}e_{Amp}(j)+k_{h,m}e_{TM}(j) (60)
where k_{h,a} and k_{h,m} are the corresponding scale factors from tapping amplitude error and deflection error to piezo displacement, respectively, which are measured a priori.

The iterative gain kᵢₙᵥ(j) is updated by using the measured input-output data as:

$${k}_{inv} ( j ) = \{ \begin{matrix}( 1 - λ ) {k}_{inv , DC} + λ \frac{{u}_{ff + gb , k} ( j )}{{h}_{k} ( j )} & \vert δ h ( j ) \leq ϵ \vert \\ {k}_{inv , DC} & otherwise\end{matrix} \qquad ( 61 )$$

and k_{inv,DC} is the inverse DC-gain of the z-axis AFM piezo-actuation system where δh(j) is the velocity of the probe given by:

δh(j)=hₖ₋₁(j)−hₖ₋₁(j−1) (62)

An inner-outer feedback loop is introduced to regulate the averaged (vertical) position of the cantilever vibration (i.e., the TM-deflection), where the outer loop is to adjust the TM-deflection setpoint through the following PID type of control (see FIG. 8),

dTMₛet(j+1)=k_{p,m}eTM(j)+k_{i,m}TMₛet(j)+k_{d,m}[eTM(j−1)−eTM(j)] (63)

eTM(j)=dTM_{d}−dTMₛet(j) (64)
and j=2, . . . , [symbol] −1, where [symbol] is the total number of sampling periods per scan line, and k_{p,m}, k_{i,m}, and k_{d,m} are the proportional, integral, and derivative coefficients, respectively.

Initially the setpoint for the outer loop dTM_d is set to the mean TM deflection at the starting point of the imaging process.

The sample topography at each k^{th} scan line h_{k,d}(j) in Eq. (60) is filtered by a Wiener filter in the FIR form as follows:

$${\hat{h}}_{k , d} [ n ] = {h}_{k , d} [ n ] - a [ n ] * {h}_{k , d} [ n ] = {h}_{k , d} [ n ] - {\sum }_{i = 0}^{N} {a}_{i} {h}_{k , d} ( n - j ) \qquad ( 65 )$$

where aᵢs are the coefficients of the Wiener filter, and they are obtained from the following equation:

$$[ \begin{matrix}{R}_{ω} [ 0 ] & {R}_{ω} [ 1 ] & … & {R}_{ω} [ N ] \\ {R}_{ω} [ 1 ] & {R}_{ω} [ 0 ] & … & {R}_{ω} [ N - 1 ] \\ ⋮ & ⋮ & ⋱ & ⋮ \\ {R}_{ω} [ N ] & {R}_{ω} [ N - 1 ] & … & {R}_{ω} [ 0 ]\end{matrix} ] [ \begin{matrix}{a}_{0} \\ {a}_{1} \\ ⋮ \\ {a}_{N}\end{matrix} ] = [ \begin{matrix}{R}_{ω s} [ 0 ] \\ {R}_{ω s} [ 1 ] \\ ⋮ \\ {R}_{ω s} [ N ]\end{matrix} ] \qquad ( 66 )$$

where R_{ω}[k] is the autocorrelation of the acoustic-noise-effected sample topography h_{d}[k]:

$${R}_{ω} [ k ] = {\sum }_{m = 0}^{N} {h}_{d} [ k ] {h}_{d} [ k - m ] , \qquad ( 67 )$$

and R_{ωs}[k] is the cross-correlation between h_{d}[k] and the sample topography disturbance by caused by the acoustic noise only z_{WN}[k] kept as follows:

$${R}_{ω s} [ k ] = {\sum }_{m = 0}^{N} {h}_{d} [ k ] {z}_{WN} [ k - m ] \qquad ( 68 )$$

The auto-correlation signal R_{ω}[k] and the cross-correlation signal R_{ωs}[k] in the above Eqs. (67), (68) are collected under the same condition as described above with respect to equations 50-52. Particularly, the sample topography caused by the acoustic-noise only, z_{WN}[k], is measured by engaging the cantilever probe to a reference hard sample at the desired preload force with the feedback control loop for the two feedback loops for the sample topography tracking closed, and measuring the z-axis piezoelectric actuator displacement (or the input voltage signal sent to drive the piezoelectric actuator) in the presence of the acoustic noise in the environment. During the measurement, the cantilever is maintained the above engagement condition without scanning.

In the above computation of the cross-correlation R_{ωs}[n], the acoustic-noise-effected sample topography h_{d}[k], can be replaced by the acoustic noise itself, n[k], measured during the imaging process.

In various embodiments, a Wiener-filter-based algorithm is provided to enhance the signal to noise ratio (SNR) of the acoustic noise measurement nₘ[k]. The acoustic noise signal is estimated by filtering the measured image signal z[k](in the presence of the acoustic noise nₘ[k]) through the Wiener filter

$${g}_{z}^{+} [ k ] ,$$

$$\hat{n} [ k ] = {g}_{z}^{+} * z [ k ] \qquad ( 69 )$$

where ‘*’ stands for the discrete-time domain convolution, and

g_{z}=[g_{z}[0]g_{z}[1] . . . g_{z}[N_{F}−1]}]^{T}

z(k)=[z[k]z[k−1] . . . z[k−N_{F}+1]]^{T}

The Wiener filter

$${g}_{z}^{+} [ k ]$$

is given by:

$${g}_{z}^{+} = {R}^{- 1} p \qquad ( 70 )$$

where R is the auto-correlation matrix of measured image signal z[k],

$$R = E \{ z ( k ) {z}^{T} ( k ) \} = [ \begin{matrix}R [ 0 ] & R [ 1 ] & … & R [ {N}_{F} - 1 ] \\ R [ 1 ] & R [ 0 ] & … & R [ {N}_{F} - 2 ] \\ ⋮ & ⋮ & ⋱ & ⋮ \\ R [ {N}_{F} - 1 ] & R [ {N}_{F} - 2 ] & … & R [ 0 ]\end{matrix} ]$$

and p is the cross-correlation between the measured acoustic noise nₘ[k] and z[k],

p=E{nₘ(k)z^{T}(k)}=[p(0)p(−1) . . . p(−N_{F}+1)]^{T}

Thus, various embodiments provide a Wiener filter that enhances the effective SNR of the acoustic noise measurement by minimizing the cross-covariance between the acoustic noise measurement error nₑ[k] and the acoustic-effected AFM image signal z[k]:

$$min {r}_{nz}^{2} [ j ] = E {\{ \hat{{n}_{e}} [ k - j ] z [ j ] \}}^{2} \qquad ( 71 )$$

Additional embodiments further enhance the effective SNR of the acoustic noise measurement through the modulator via the coherence minimization described above. It is noted that the modulator-enhanced FIR filter can be used independently without using the acoustic dynamics dictionary, to compensate for the effect of unknown noise source location on the acoustic noise dynamics measurement, and thereby, directly cancel the acoustic-caused AFM image distortions. Thus, various embodiments provide modulation of one or more filters, such as modulation of an acoustic noise filter to optimize thereby a filter configured to minimize acoustic-noise-caused distortions in AFM images.

### Vibration & Vibration+Noise Mitigation Embodiments

The various embodiments discussed above are primarily directed to mitigating image distortions related to acoustic noise experienced by equipment associated with Atomic Force Microscopy (AFM) and other processes sensitive to acoustic noise and similar disturbances.

Additional embodiments may be directed to mitigating image distortions related to vibrations or a combination of vibrations and acoustic noise experienced by equipment associated with AFM and other processes sensitive to vibrations and similar disturbances.

Various embodiments will now be discussed within the context of modulator-based signal noise ratio optimization via coherence maximization. Specifically, various embodiments will now be discussed within the context of methodologies of active ground vibration cancellation using accelerometers, active acoustic noise and ground vibration cancellation by combining accelerometers and microphones together, and fusion of multiple sensor signals to optimize the signal to noise ratio, such as for atomic force microscope (AFM) and other precision instruments (e.g., scanning electronic microscopes, confocal microscopes, and/or other precision instruments).

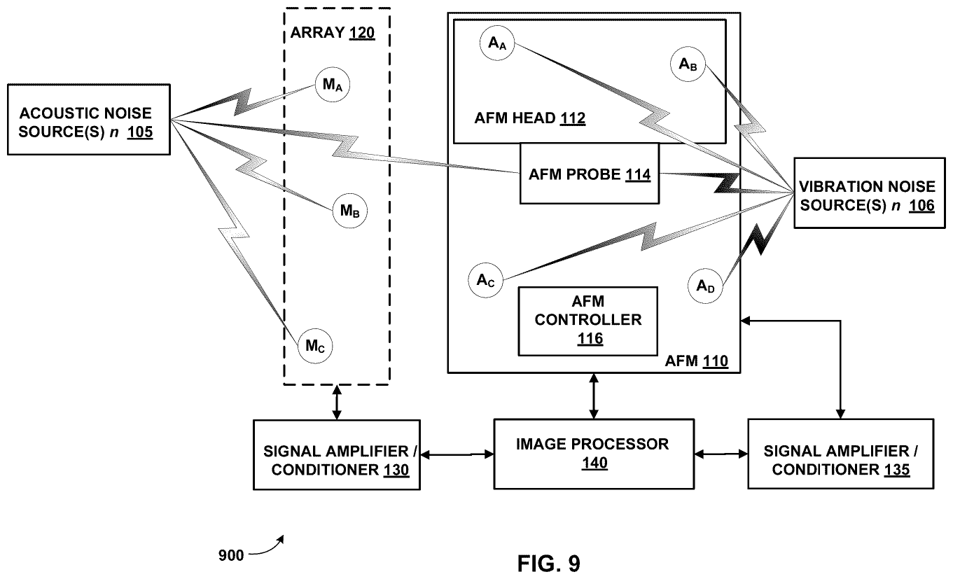

FIG. 9 depicts an AFM system benefiting from the various embodiments. Specifically, FIG. 9 depicts an AFM system 900 similar to the AFM system 100 depicted above with respect to FIG. 1, but further modified to mitigate image distortions related to vibrations alone, or to mitigate image distortions related to a combination of vibrations and acoustic noise.

FIG. 9 (like FIG. 1) depicts an AFM 110 comprising an AFM head 112 configured to cause scanning of a sample surface (not shown) by an AFM probe 112. An AFM controller 116 is configured to manage the various control and input/output functions of the AFM 110, such as providing AFM image data to an image processor 140. The image processor 140 is configured to process the AFM image data in accordance with the various embodiments, as will be discussed below.

For embodiments mitigating image distortions related to acoustic noise, the AFM system 900 of FIG. 9 is configured similarly to the AFM system 100 of FIG. 1; namely, to include a microphone array 120 comprising, illustratively, three microphones denoted as microphones MA, MB, and MC (collectively microphones M of the array 120) and an optional microphone signal amplification/conditioning circuitry 130. Acoustic information such as sounds/vibrations proximate the AFM 110 such as from an acoustic noise source 105 are received by the microphones M, which provide corresponding acoustic information signals that are provided to the image processor 140, optionally via microphone signal amplification/conditioning circuitry 130. It is noted that the sounds/vibrations proximate the AFM 110 such as from the acoustic noise source 105 are also “received” by the AFM probe 114, either directly from the noise source 105 (or acoustic transmissive media therebetween), or indirectly via other portions of the AFM 110 that are also impacted or perturbed by sounds/vibrations proximate the AFM 110 and mechanically cooperating with the AFM probe 114 so as to transmit sounds/vibrations thereto.

For embodiments mitigating image distortions related to vibrations, the AFM system 900 of FIG. 9 is configured to include one or more vibration sensors such as accelerometers directly connected to or disposed upon the AFM 110 or portions thereof (e.g., the housing or chassis of the AFM 110, the AFM head 112, or some other location) and denoted as accelerometers A_{A}, A_{B}, A_{C}, and A_{D} (collectively accelerometers A) and optional accelerometer signal amplification/conditioning circuitry 135. Vibration information experienced by the AFM 110 or portions thereof such as from a vibration source 106 are sensed by the accelerometers A, which generate corresponding vibration information signals that are provided to the image processor 140, optionally via signal amplification/conditioning circuitry 136. It is noted that vibrations proximate the AFM 110 such as from the acoustic noise source 106 are also “received” by the AFM probe 114, either directly from the vibration source 106 (or vibration transmissive media therebetween), or indirectly via other portions of the AFM 110 that are also impacted or perturbed by vibrations proximate the AFM 110 and mechanically cooperating with the AFM probe 114 so as to transmit vibrations thereto.

The effect of acoustic noise and/or vibrations is to reduce AFM imaging quality. For example, in tapping mode (TM) imaging, a cantilever tip is excited (usually using a small piezo stack actuator, called a dither piezo) and taps on the sample surface, and the tapping amplitude is maintained around a pre-chosen constant level under feedback control, when the tip is scanning across the surface. Then, a sample topography image is obtained from the (vertical) displacement of the cantilever. In the presence of environmental acoustic noise and/or vibrations, the mechanical structure of the AFM (on which the cantilever is mounted) can be excited and vibrate, resulting in unwanted cantilever vibration with respect to the sample and, thereby, image distortion.

FIG. 9 illustratively depicts a first pair of accelerometers (A_{C} and A_{D}) as being attached to the AFM system 110 (e.g., a chassis or other vibration conduit), and a second pair of accelerometers (A_{A} and A_{B}) as being attached to the AFM head 112. It is noted that fewer accelerometers or more accelerometers A may be attached to the AFM system 110 or portions thereof. It is also noted that a single accelerometer A attached only to one of the AFM system 110 or a portion thereof may also be used in various embodiments.

Whether one accelerometer A is used, or multiple accelerometers A are used, each accelerometer A is configured to sense or measure ground vibration and the like transmitted to the AFM system, which vibration may result in extra cantilever vibration and subsequent image errors or distortion.

In particular, the sensors/accelerometers A are configured to measure vibration indicative displacement of the AFM system or portions thereof, such as a cantilever deflection signal, which measurements are used to process obtained images such as by the filtering and/or vibration cancelling algorithms described below. Using this algorithm-based method, the optical table currently used in AFM systems can be replaced or can be further enhanced for vibration isolation (e.g., by combining the below described vibration processing techniques with the above-described noise processing techniques).

Consider the existence of multiple noise or ground vibration signals, denoted as n₁[k], n₂[k], . . . , n_{M}[k] and collected from multiples sensors where M is the number of sensors (M=4 in the exemplary embodiment of FIG. 9). An optimal estimation of the noise signal (or the ground vibration signal), \hat{n}*[k], is obtained in one embodiment by finding a set of frequency-dependent and source-dependent coefficients

$${α}_{i}^{*} ( j {ω}_{k} ) ∈ ℂ$$

as in the following:

$${\hat{N}}^{*} ( j {ω}_{k} , {α}_{i , t} ) = {\sum }_{i = 1}^{M} {α}_{i}^{*} ( j {ω}_{k} ) {N}_{i} ( j {ω}_{k} ) , {ω}_{k} ∈ {𝕊}_{ω} \qquad ( 72 )$$

where at each given frequency ωₖ,

$${\sum }_{i = 1}^{M} {α}_{i}^{*} = 1 \qquad ( 73 )$$

such that the signal-noise-ratio (SNR) with respect to the noise (or ground vibration) caused response z(t) is maximized in the sense that the difference between the power spectral densities and the coherence between the noise (vibration) and the noise (vibration)-caused response is minimized, such as provided by:

$$min {𝒥}_{c} = {\sum }_{k = 1}^{{N}_{F}} ( {P}_{N} ( j {ω}_{k} ) {P}_{Z} ( j {ω}_{k} ) - {E [ {\hat{N}}^{*} ( j {ω}_{k} ) Z ( j {ω}_{k} ) ]}^{2} ) \qquad ( 74 )$$

In the above Eqs. (72-74), N*(jωₖ,α_{i,t}) and Z(jω) denote the fourier transform of the optimal estimation of the noise (vibration) signal \hat{n}(t) and the noise (vibration) caused response on AFM z(t) (i.e, the piezo displacement or the cantilever deflection), P_{N}(jωₖ) and P_{z}_{_{F}}(jωₖ) are the power spectral densities of \hat{N}(jωₖ) and Z(jωₖ), respectively, and [symbol] is the set of the sampled discretized frequencies, as follows:

$${𝕊}_{ω} = \{ \frac{k {ω}_{s}}{{N}_{I}} \vert k = 0 , 1 , … , {N}_{I} - 1 , and {ω}_{s} = 2 π {f}_{s} \} \qquad ( 75 )$$

where N_{F} denotes the total number of effective frequency components in the noise source n[k], i.e., ω_{N}_{_{F}} is the lowest frequency at which the magnitude of \hat{N}(jωₖ) becomes negligible, e.g., |\hat{N}(jωₖ)|≤ϵₙ for all ωₖ≥N_{F} and chosen threshold ϵₙ.

In various embodiments, optimal coefficients αᵢ*(jωₖ)s are obtained through the gradient descent search method; that is, for any given ωₖ∈ [symbol] ,

$$\begin{matrix}with {α}_{i , t} ( j {ω}_{k} ) = {α}_{i , t - 1} ( j {ω}_{k} ) + λ \frac{\partial {𝒥}_{c}}{\partial {\hat{N}}_{t - 1} ( j {ω}_{k} )} \\ = {α}_{i , t - 1} ( j {ω}_{k} ) + λ \frac{\partial {𝒥}_{c}}{\partial {α}_{i , t - 1} ( j {ω}_{k} )} \frac{1}{{N}_{i} ( j {ω}_{k} )}\end{matrix} \qquad ( 76 )$$

for i≥1, where initially α_{i,0} is chosen as

$$\frac{1}{M} ,$$

λ∈(0,1) is a pre-chosen constant to ensure the increase of the coherence.

The coefficient obtained after each iteration is normalized before the next iteration:

$${\hat{α}}_{i , t} ( j {ω}_{k} ) = \frac{{α}_{i , t} ( j {ω}_{k} )}{{\sum }_{i = 1}^{M} {α}_{i , t} ( j {ω}_{k} )} \qquad ( 77 )$$

The above correlation minimization in, e.g., Eq. (74) is converted to minimizing the difference between the corresponding coherence between these two signals and 1 (the upper limit of coherence), C_{nz}(jωₖ), by normalizing J_{c} with the (estimated) power spectral density of Z(jωₖ) and \hat{N}(jωₖ), as follows:

$$min {𝒥}_{c} = {\sum }_{k = 1}^{{N}_{F}} ( 1 - \frac{{E [ {\hat{N}}^{*} ( j {ω}_{k} ) Z ( j {ω}_{k} ) ]}^{2}}{{P}_{N} ( j {ω}_{k} ) {P}_{Z} ( j {ω}_{k} )} ) \qquad ( 78 )$$

$${=}^{Δ} {\sum }_{k = 1}^{{N}_{F}} [ 1 - {C}_{nz} ( j {ω}_{k} ) ] \qquad ( 79 )$$

When the difference between the coherence C_{nf}(jωₖ)∈(0,1) and its upper bound value of 1 is minimized, so is [symbol] . Thus, the gradient-based iteration in Eq. (76) is converted to:

$${α}_{i , t} ( j {ω}_{k} ) = {α}_{i , t - 1} ( j {ω}_{k} ) + λ \frac{\partial {C}_{nz} ( j {ω}_{k} , {α}_{i , t - 1} )}{\partial {\hat{N}}_{i , t - 1} ( j {ω}_{k} )} \qquad ( 80 )$$

$$= {α}_{i , t - 1} ( j {ω}_{k} ) + λ \frac{\partial {C}_{nz} ( j {ω}_{k} , {α}_{i , t - 1} )}{\partial {α}_{i , t - 1} ( j {ω}_{k} )} \frac{1}{{N}_{i} ( j {ω}_{k} )} \qquad ( 81 )$$

where C_{nz}(jωₖ,α_{i,t}) is the coherence computed by modulator value obtained in the t^{th} iteration, αᵢ(jωₖ), and the partial derivative is computed numerically via the first-order Euler formula:

$$\frac{\partial {C}_{nz} ( j {ω}_{k} , {α}_{i , t} )}{\partial {α}_{i , t} ( j {ω}_{k} )} \approx \frac{{c}_{nz} ( j {ω}_{k} , {α}_{i , t} + δα ) - {c}_{nz} ( j {ω}_{k} , {α}_{i , t} )}{δα} \qquad ( 82 )$$

In various embodiments, the coherence C_{nz}(jωₖ,α_{i,t}) is computed using he Welch's Method as the average of the short-segment coherence Ĉ_{nz,r}(jωₖ,α_{i,t}), i.e., for any given αi, t,

$${C}_{nz} ( j {ω}_{k} , {α}_{i , t} ) \approx {\hat{C}}_{nz} ( j {ω}_{k} , {α}_{i , t} ) = \frac{{\sum }_{r = 1}^{{M}_{c}} {C}_{nz , r} ( j {ω}_{k} , {α}_{i , t} )}{{M}_{c}} \qquad ( 83 )$$

$$with {C}_{nz , r} ( j {ω}_{k} , {α}_{i , t} ) = \frac{{\vert {N}_{r}^{*} ( j {ω}_{k} ) {Z}_{r} ( j {ω}_{k} , {α}_{i , t} ) \vert}^{2}}{{P}_{N , r} ( j {ω}_{k} ) {P}_{Z , r} ( j {ω}_{k} , {α}_{i , t} )} \qquad ( 84 )$$

for i≥1, where Nᵣ(jωₖ) and Zᵣ(jωₖ,α) are the Fourier transform of the r^{th} segment of the estimated noise signal \hat{n}[k] and the raw image signal z[k], respectively, obtained by partitioning the sequence of \hat{n}[k] and z[k] into M_{c} segments, respectively,

\hat{n}=[n₁n₂ . . . nᵣ . . . n_{M}_{_{c}}] and (85)

z=[z₁z₂ . . . zᵣ . . . z_{M}_{_{c}}], where (86)

nᵣ=[n((r−1)L+1),n((r−1)L+2, . . . ,n(rL)] (87)

zᵣ=[zᵣ[(r−1)L+1],zᵣ[(r−1)L+2], . . . ,zᵣ(rL)]. (88)
where the length of each segment L is chosen such that the sampled frequency resolution of each segment is high enough to capture the frequencies where the peak of coherence occurs, i.e., fₛ/L≤ϵ_{f} for ϵ_{f} is the chosen frequency resolution.

In various embodiments, the minimization in Eq. (78) is further modified as:

$$min {𝒥}_{c} = {\sum }_{k = 1}^{{N}_{F}} 1 - {\hat{C}}_{nz} ( j {ω}_{k} ) + Var [ {\hat{C}}_{nz} ( j {ω}_{k} ) ] \qquad ( 89 )$$

where Var[Ĉ_{nz}(jωₖ)] is the variance of the estimated Ĉ_{nz}(jωₖ), and:

$${lim}_{{N}_{I} \to ∞} Var [ {\hat{C}}_{nz , t} ( j {ω}_{k} ) ] = E \{ {[ {\hat{C}}_{nz , t} ( j {ω}_{k} ) - {C}_{nz , t} ( j {ω}_{k} ) ]}^{2} \} \approx \frac{1}{r} \qquad ( 90 )$$

With the above modification, the computation in Eqs. (79) to (85) are carried out by replacing Ĉ_{nz}(jωₖ) with

$${\hat{C}}_{nz} ( j {ω}_{k} ) - \frac{1}{r} .$$

Vibration-caused image distortion may be reduced via corresponding vibration coherence minimization via a gradient-based iterative method to minimize the coherence Ĉ_{nz}(jωₖ,α_{i,t}) between the vibration and the residual vibration-caused image distortion, and to update the optimized noise signal \hat{n}*[k]. An updated coherence Ĉ_{nz}(jωₖ,α_{i,t}) is computed. An optimized filter (i.e., a vibration dynamics model, optionally including an acoustic dynamics model) may be provided to enable online or offline processing of the image or portions thereof, such as described above with respect to acoustic noise filtering. The filtering scheme may be implemented on AFM image examples.

Various embodiments contemplate online active acoustic-rejection-mode (ARM) imaging to handle acoustic-noise-caused cantilever probe vibration during AFM imaging, active vibration-rejection-mode (VRM) imaging to handle vibration-caused cantilever probe vibration during AFM imaging, or active vibration-acoustic-rejection-mode (VARM) imaging to handle vibration-caused and acoustic-noise-caused cantilever probe vibration during AFM imaging,

A pre-filter to online adjust the set point of a feedback loop for topography tracking may be provided to make an AFM system, VRM system, or VARM system robust to the environment vibration or acoustic noise. Further, a feedforward controller based on the PAD model of the acoustic noise effect on the AFM system may be augmented to counter act noise-caused vibration, as previously described.

Various embodiments provide active vibration and/or noise control/cancellation suitable for use in AFM imaging applications and the like so as to reduce or eliminate image distortion caused by vibration and/or acoustic noise. Some embodiments provide active vibration and/or noise control/cancellation during an SPM imaging or image acquisition process, while others provide active vibration and/or noise cancellation afterwards through a post-imaging process.

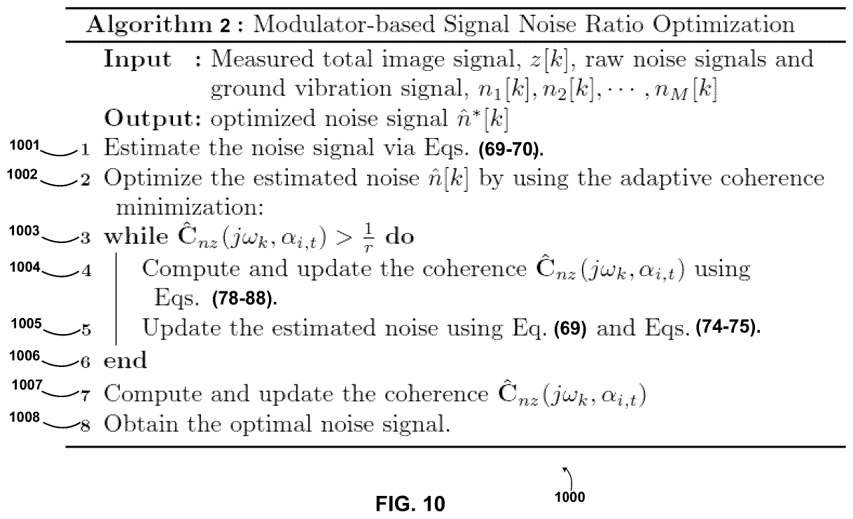

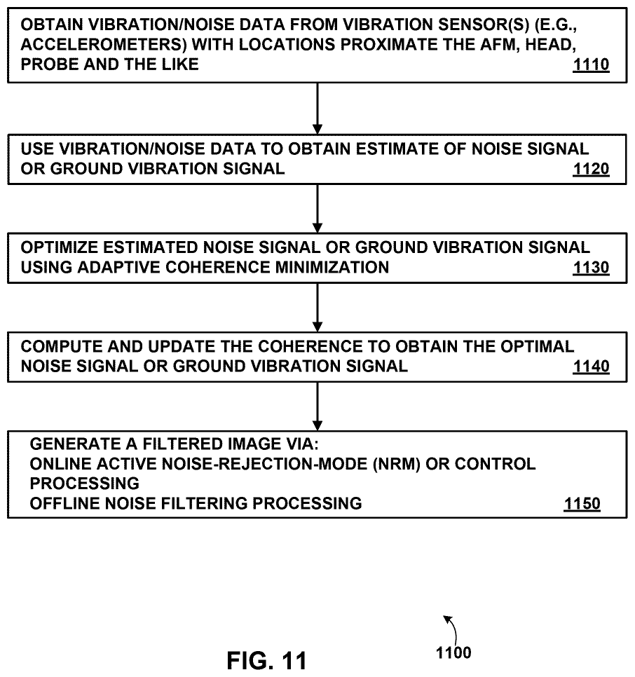

FIG. 10 depicts a pseudocode representation of a method for vibration filtering according to an embodiment. Specifically, a methodology according to an embodiment for implementing vibration filtering is summarized in FIG. 10 and Algorithm 2 as presented below. FIG. 11 depicts a flow diagram of a method according to an embodiment and in accordance with the method of FIG. 10. It is noted that the description of FIGS. 10 and 11 are similar and, as such, will be presented together.

Briefly, Algorithm 2 of FIG. 10 and method 1100 of FIG. 11 provide modulator-based signal noise ratio optimization by processing measured total image signal, z[k], raw noise signals and ground vibration signal, n₁[k], n₂[k], . . . , n_{M}[k] to provide therefrom optimized noise signal \hat{n}*[k]. Referring to FIG. 11, at step 1110 vibration/noise data is obtained from one or more vibration sensors, such as accelerometers firmly adhered or attached to locations on, e.g., an AFM such as on the body or chassis thereof, or on the body/chassis of a portion thereof such as a probe portion, head portions, and the like.

At step 1120 (step 1001 of the method 1000 of FIG. 10), the vibration/noise data is used to obtain an estimate of the noise signal or ground vibration signal (estimated noise signal n\hat{ }[k]), such as described above with respect to at least equations 72-73.

At step 1130 (steps 1002-1006 of the method 1000 of FIG. 10), the estimated noise signal n\hat{ }[k] is optimized using adaptive coherence minimization, such as by iteratively computing and updating the coherence Ĉ_{nz}(jωₖ,α_{i,t}) as described above with respect to at least equations 78-88, and updating the estimated noise signal n\hat{ }[k] as described above with respect to at least equations 72, and 77-78, until the following statement is false:

$${\hat{C}}_{nz} ( j {ω}_{k} , {α}_{i , t} ) > \frac{1}{r} .$$

At step 1140 (steps 1007-1008 of the method 1000 of FIG. 10), the coherence Ĉ_{nz}(jωₖ,α_{i,t}) is computed and updated to obtain an optimal noise signal or ground vibration signal.

At step 1150, the obtained optimal noise signal and/or ground signal is used to generate a filtered image, such as via online active noise-rejection-mode (NRM) or control processing, and/or offline noise filtering processing, both of which are described above with respect to various embodiments.

Various computing and/or processing functions as described herein may be performed using standard computing techniques, such as via a special purpose or general-purpose computer configured to perform the computing and/or processing function and including processing, memory, and input/output (I/O) circuitry and the like. For example, a controller or processor may be configured to perform various computing and/or processing functions in response to computer instructions stored in a non-transitory computer readable memory. As such, the various functions depicted and described herein may be implemented at the elements or portions thereof as hardware or a combination of software and hardware, such as by using a general-purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus, various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory or stored within a memory within a computing device operating according to the instructions.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method of processing an image including distortion induced by the presence of vibration during the generation of the image, comprising:
receiving vibration data from each of at least one vibration sensors proximate an imaging device during operation of the imaging device to generate the image;
using the vibration data to determine an estimated noise signal n\hat{ }[k];
iteratively minimizing coherence between the vibration noise and residual vibration-caused image distortion to obtain updated noise signal n\hat{ }[k] and coherence Ĉ_{nz}(jωₖ,α_{i,t}); and
generating filtered image data using the updated noise signal n\hat{ }[k] and coherence Ĉ_{nz}(jωₖ,α_{i,t}).

2. The method of claim 1, wherein the filtered image data is generated using image data of an entire captured image.

3. The method of claim 1, wherein the filtered image data is generated using image data of a partially captured image.

4. The method of claim 1, wherein the imaging device comprises an Atomic Force Microscopy (AFM) device.

5. The method of claim 1, wherein the vibration sensors comprise accelerometers.

6. The method of claim 2, wherein at least one vibration sensor is attached directly to a portion of the AFM device and comprises an accelerometer.

7. The method of claim 1, further comprising using a Wiener filter to minimize cross-covariance between acoustic noise measurement error nₑ[k] and acoustic-effected AFM image signal z[k].

8. The method of claim 1, wherein the image further includes distortion induced by the presence of acoustic noise during the generation of the image, comprising:
receiving acoustic noise data from each of a plurality of microphones proximate an imaging device during operation of the imaging device to generate the image;
using the acoustic noise data to determine an acoustic noise source location;
using a dictionary-based method to estimate a primary acoustic dynamic (PAD) of the acoustic noise based on the determined location of the acoustic noise source;
using a dictionary-based method to estimate the acoustic noise signal;
using the estimated PAD and the estimated noise signal to obtain an initial filtered image; and
optimizing a filter using adaptive coherence minimization to obtain thereby a filtered image.

9. The method of claim 8, wherein the plurality of microphones proximate the imaging device comprises three microphones M_{A}, M_{B}, and M_{C} placed at respective known locations a, b, and c, and the acoustic noise source location is estimated with respect to sensor-source distances calculated using the acoustic noise data and known locations of the three microphones.

10. A method of processing an image including distortion induced by the presence of acoustic noise during the generation of the image, comprising:
receiving acoustic noise data from each of a plurality of microphones proximate an imaging device during operation of the imaging device to generate the image;
using the acoustic noise data to determine an acoustic noise source location;
using a dictionary-based method to estimate a primary acoustic dynamic (PAD) of the acoustic noise based on the determined location of the acoustic noise source;
using a dictionary-based method to estimate the acoustic noise signal;
using the estimated PAD and the estimated noise signal to obtain an initial filtered image; and
optimizing a filter using adaptive coherence minimization to obtain thereby a filtered image.

11. The method of claim 10, wherein the imaging device comprises an Atomic Force Microscopy (AFM) device.

12. The method of claim 10, wherein the plurality of microphones proximate the imaging device comprises three microphones M_{A}, M_{B}, and M_{C} placed at respective known locations a, b, and c, and the acoustic noise source location is estimated with respect to sensor-source distances calculated using the acoustic noise data and known locations of the three microphones.

13. The method of claim 10, further comprising:
constructing, for use in the dictionary-based method to estimate the PAD of the acoustic noise, a dictionary of frequency responses of the PAD measured at selected locations, [symbol] , in accordance with the following equation: [symbol]
={Gₙ( [symbol] ,jωₖ)| [symbol] ∈ [symbol] ,ωₖ∈ [symbol] , p=1, . . . ,Nᵣ, and q=1, . . . ,N_{θ}}.

14. The method of claim 10, further comprising:
constructing, for use in the dictionary-based method to estimate the acoustic noise signal, a dictionary of noise propagation dynamics (NPD) measured at selected locations, [symbol] , in accordance with the following equation: [symbol]
={Gₙₚ( [symbol] ,jωₖ)| [symbol] ∈ [symbol] ,ωₖ∈ [symbol] , i=1,2, . . . Nᵣ, j−1,2, . . . N_{θ}}.

15. The method of claim 10, wherein the initial filtered image is obtained using a finite impulse response (FIR) filter g_{N}[k] configured to process an image noise signal \hat{z}ₙ[k].

16. The method of claim 10, wherein the image further includes distortion induced by the presence of acoustic noise during the generation of the image, comprising:
receiving acoustic noise data from each of a plurality of microphones proximate an imaging device during operation of the imaging device to generate the image;
using the acoustic noise data to determine an acoustic noise source location;
using a dictionary-based method to estimate a primary acoustic dynamic (PAD) of the acoustic noise based on the determined location of the acoustic noise source;
using a dictionary-based method to estimate the acoustic noise signal;
using the estimated PAD and the estimated noise signal to obtain an initial filtered image; and
optimizing a filter using adaptive coherence minimization to obtain thereby a filtered image.

17. The method of claim 16, wherein the plurality of microphones proximate the imaging device comprises three microphones M_{A}, M_{B}, and M_{C} placed at respective known locations a, b, and c, and the acoustic noise source location is estimated with respect to sensor-source distances calculated using the acoustic noise data and known locations of the three microphones.

18. An image processor configured to cooperate with an Atomic Force Microscopy (AFM) system to process image data provided therefrom, the AFM system configured for scanning a sample surface with an AFM probe to generate image data thereby, the AFM system further comprising at least one vibration sensor configured to sense vibration imparted to the AFM to generate vibration data thereby, the image processor configured to perform a method of processing image data representing an image including distortion induced by the presence of vibration during the generation of the image, comprising:
receiving vibration data from each of at least one vibration sensor proximate the AFM system during operation of the AFM system to generate the image;
using the vibration data to determine an estimated noise signal n\hat{ }[k];
iteratively minimizing coherence between the vibration noise and residual vibration-caused image distortion to obtain updated noise signal n\hat{ }[k] and coherence Ĉ_{nz}(jωₖ,α_{i,t}); and
generating filtered image data using the updated noise signal n\hat{ }[k] and coherence Ĉ_{nz}(jωₖ,α_{i,t}).

19. The image processor of claim 18, wherein at least one vibration sensor is attached directly to a portion of the AFM device and comprises an accelerometer.

20. The image processor of claim 18, wherein the method further comprises using a Wiener filter to minimize cross-covariance between acoustic noise measurement error nₑ[k] and acoustic-effected AFM image signal z[k].

21. The image processor of claim 18, wherein each of a plurality of microphones proximate the AFM system is configured for generating respective data indicative of acoustic noise sensed thereat, wherein the method further comprises:
receiving acoustic noise data from each of the plurality of microphones proximate the AFM system during operation of the AFM system to generate an image;
using the acoustic noise data to determine an acoustic noise source location;
using a dictionary-based method to estimate a primary acoustic dynamic (PAD) of the acoustic noise based on the determined location of the acoustic noise source;
using a dictionary-based method to estimate the acoustic noise signal;
using the estimated PAD and the estimated noise signal to obtain an initial filtered image; and
optimizing a filter using adaptive coherence minimization to obtain thereby a filtered image.

22. The image processor of claim 18, wherein the plurality of microphones proximate the AFM system comprises three microphones M_{A}, M_{B}, and M_{C} placed at respective known locations a, b, and c, and the acoustic noise source location is estimated with respect to sensor-source distances calculated using the acoustic noise data and known locations of the three microphones.
